(19) United States
(12) Patent Application Publication
(10) Pub. No.: US 2014/0282272 A1
(43) Pub. Date: Sep. 18, 2014

(54) Interactive Inputs for a Background Task

(71) Applicant: QUALCOMM INCORPORATED, San Diego, CA (US)

(72) Inventors: Jonathan K. KIES, Encinitas, CA (US); Francis B. MacDOUGALL, Toronto (CA); Suzana ARELLANO, San Diego, CA (US)

(73) Assignee: QUALCOMM INCORPORATED, San Diego, CA (US)

(21) Appl. No.: 13/837,006

(22) Filed: Mar. 15, 2013

(51) Int. Cl. G06F 3/01

(52) U.S. Cl. CPC G06F 3/017
USPC 715/863

(57) ABSTRACT

Systems and methods according to one or more embodiments of the present disclosure provide improved multitasking on user devices. In an embodiment, a method for multitasking comprises detecting a non-touch gesture input received by a user device. The method also comprises associating the non-touch gesture input with an application running in a background, wherein a different focused application is running in a foreground. And the method also comprises controlling the background application with the associated non-touch gesture input without affecting the foreground application.

### TECHNICAL FIELD

Embodiments of the present disclosure generally relate to user devices, and more particularly, to detecting non-touch interactive inputs to affect tasks or applications.

### BACKGROUND

Currently, user devices (e.g., smart phones, tablets, laptops, etc.) generally have computing device processors that are capable of running more than one application or task at a time. To control an application or task, a user may be able to navigate to the application or task that the user wants to control, or alternatively, the user may be able to “pull down” a menu or a list of controls for applications or tasks.

In an example for integrated car systems, voice controls may allow users to give inputs for functions after first making voice input the primary task. For instance, when the radio is playing, the user may press a button for voice command. The radio then mutes and the user may give a voice command such as “set temperature to 78 degrees.” The temperature is changed and the radio is then un-muted. As such, voice controls, when they are made the primary task, may allow users to give input to applications. However, such available controls may not work in other situations.

Accordingly, there is a need in the art for improving multitasking on a user device.

### SUMMARY

Systems and methods according to one or more embodiments are provided for using interactive inputs such as non-touch gestures as input commands for affecting or controlling applications or tasks, for example, applications that are not the currently focused task or application, e.g., background tasks or applications, without affecting the focused task or application, e.g., a foreground task or application.

According to an embodiment, a method for controlling a background application comprises detecting a non-touch gesture input received by a user device. The method also comprises associating the non-touch gesture input with an application running in a background, wherein a different focused application is running in a foreground. And the method further comprises controlling the background application with the associated non-touch gesture input without affecting the foreground application.

According to anther embodiment, a device comprises an input configured to detect a non-touch gesture input; and one or more processors configured to: associate the non-touch gesture input with an application running in a background, wherein a different focused application is running in a foreground; and control the background application with the associated non-touch gesture input without affecting the foreground application. In an embodiment, the processor(s) is further configured to display an overlay over the focused application on the interface of the user device, wherein the overlay indicates that non-touch gesture inputs are available to affect the background application. In another embodiment, the non-touch gesture input comprises a pose or a motion by an object, gaze or eye tracking. In another embodiment, the processor(s) is further configured to use a global look-up table indicating specific non-touch gesture inputs assigned to corresponding commands for corresponding specific applications. In another embodiment, the processor(s) is further configured to assign non-touch gesture inputs to corresponding commands for applications based on a current output state of the user device. In another embodiment, the processor(s) is further configured to: detect a non-touch gesture input that is registered for the foreground application and the background application; and select an active non-touch gesture input application for applying the detected non-touch gesture input. In another embodiment, the processor(s) is further configured to detect an engagement pose designating a background application to control and that is maintained for a predetermined period of time, and providing an overlay that allows a user to switch control to the background application. In another embodiment, the processor(s) is further configured to detect an engagement pose designating a background application to control and that is maintained for a predetermined period of time, and automatically switching to control the background application without losing focus on the foreground application. In another embodiment, the processor(s) is further configured to detect a specific non-touch gesture input that signifies that a user wants to engage with the background application. In another embodiment, the processor(s) is further configured to detect a single non-touch gesture input that is allocated for selecting between two or more applications. In another embodiment, the processor(s) is further configured to enable a mode in which non-touch gesture input engagement is automatically connected to a last selected application. In another embodiment, the processor(s) is further configured to register the background application for specific non-touch gesture inputs when the background application launches, and unregistering the background application for the specific non-touch gesture inputs when it exits. In another embodiment, elements of the background application are not displayed while the focused application is running in a foreground.

According to another embodiment, an apparatus for controlling a background application comprises: means for detecting a non-touch gesture input received by the apparatus; means for associating the non-touch gesture input with an application running in a background, wherein a different focused application is running in a foreground; and means for controlling the background application with the associated non-touch gesture input without affecting the foreground application. In an embodiment, the focused application is displayed on displaying means of the apparatus. In another embodiment, the apparatus further comprises means for displaying an overlay over the focused application on displaying means of the apparatus, wherein the overlay indicates that non-touch gesture inputs are available to affect the background application. In another embodiment, the non-touch gesture input comprises a pose or a motion by an object, gaze or eye tracking. In another embodiment, the apparatus further comprises means for using a global look-up table indicating specific non-touch gesture inputs assigned to corresponding commands for corresponding specific applications. In another embodiment, the apparatus further comprises means for assigning non-touch gesture inputs to corresponding commands for applications based on a current output state of the user device. In another embodiment, the apparatus further comprises means for detecting a non-touch gesture input that is registered for the foreground application and the background application; and means for selecting an active non-touch gesture input application for applying the detected non-touch gesture input. In another embodiment, the apparatus further comprises means for detecting an engagement pose designating a background application to control and that is maintained for a predetermined period of time, and means for providing an overlay that allows a user to switch control to the background application. In another embodiment, the apparatus further comprises means for detecting an engagement pose designating a background application to control and that is maintained for a predetermined period of time, and means for automatically switching to control the background application without losing focus on the foreground application. In another embodiment, the apparatus further comprises means for detecting a specific non-touch gesture input that signifies that a user wants to engage with the background application. In another embodiment, the apparatus further comprises means for detecting a single non-touch gesture input that is allocated for selecting between two or more applications. In another embodiment, the apparatus further comprises means for enabling a mode in which non-touch gesture input engagement is automatically connected to a last selected application. In another embodiment, the apparatus further comprises means for registering the background application for specific non-touch gesture inputs when the background application launches, and means for unregistering the background application for the specific non-touch gesture inputs when it exits. In another embodiment, the apparatus further comprises elements of the background application that are not displayed while the focused application is running in a foreground.

According to another embodiment, a non-transitory computer readable medium on which are stored computer readable instructions which, when executed by a processor, cause the processor to: detect a non-touch gesture input received by a user device, associate the non-touch gesture input with an application running in a background, wherein a different focused application is running in a foreground, and control the background application with the associated non-touch gesture input without affecting the foreground application. In an embodiment, the instructions are further configured to cause the processor to display an overlay over the focused application on the interface of the user device, wherein the overlay indicates that non-touch gesture inputs are available to affect the background application. In another embodiment, the non-touch gesture input comprises a pose or a motion by an object. In another embodiment, the instructions are further configured to cause the processor to use a global look-up table indicating specific non-touch gesture inputs assigned to corresponding commands for corresponding specific applications. In another embodiment, the instructions are further configured to cause the processor to assign non-touch gesture inputs to corresponding commands for applications based on a current output state of the user device. In another embodiment, the instructions are further configured to cause the processor to: detect a non-touch gesture input that is registered for the foreground application and the background application; and select an active non-touch gesture input application for applying the detected non-touch gesture input. In another embodiment, the instructions are further configured to cause the processor to detect an engagement pose designating a background application to control and that is maintained for a predetermined period of time, and provide an overlay that allows a user to switch control to the background application. In another embodiment, the instructions are further configured to cause the processor to detect an engagement pose designating a background application to control and that is maintained for a predetermined period of time, and automatically switching to control the background application without losing focus on the foreground application. In another embodiment, the instructions are further configured to cause the processor to detect a specific non-touch gesture input that signifies that a user wants to engage with the background application. In another embodiment, the processor is further configured to detect a single non-touch gesture input that is allocated for selecting between two or more applications. In another embodiment, the instructions are further configured to cause the processor to enable a mode in which non-touch gesture input engagement is automatically connected to a last selected application. In another embodiment, the instructions are further configured to cause the processor to register the background application for specific non-touch gesture inputs when the background application launches, and unregistering the background application for the specific non-touch gesture inputs when it exits. In another embodiment, elements of the background application are not displayed while the focused application is running in a foreground.

### BRIEF DESCRIPTION OF THE DRAWINGS

FIG. 1 is a flow diagram illustrating a method for multitasking on a user device according to an embodiment of the present disclosure.

FIG. 2 is a flow diagram illustrating a music control use case according to an embodiment of the present disclosure.

FIG. 3 is a flow diagram illustrating a method for determining an application to which interactive inputs apply according to an embodiment of the present disclosure.

FIG. 4 is a flow diagram illustrating a method for using non-touch gestures registered to control an application according to an embodiment of the present disclosure.

FIG. 5 is a block diagram illustrating handling active gesture application selection according to an embodiment of the present disclosure.

FIG. 6 is a diagram illustrating an example of handling a background task gesture according to an embodiment of the present disclosure.

FIG. 7 is a block diagram of a system for implementing a device is illustrated according to an embodiment of the present disclosure.

FIG. 8 is a block diagram illustrating a method for controlling an application according to an embodiment of the present disclosure.

### DETAILED DESCRIPTION

Systems and methods according to one or more embodiments are provided for associating interactive commands or inputs such as non-touch gestures with a specific application or task even when the application or task is running in the background without affecting a currently focused task or application, i.e., a foreground task or application.

A focused task or application may be, for example, an application that is currently displayed on an interface of a user device. Non-touch gestures may be used as input for an application that is not the currently focused or displayed application. In this way, true multitasking may be allowed on user devices, especially on ones that may display only one task or application at a time.

Referring to the drawings wherein the showings are for purposes of illustrating embodiments of the present disclosure only, and not for purposes of limiting the same, FIG. 1 is a flow diagram illustrating a method for multitasking on a user device according to an embodiment of the present disclosure.

In block 102, an active application or task (“foreground application”) may be displayed on a user device interface, for example on a display component 1514 illustrated in FIG. 7. User devices may generally be able to display limitless types of applications such as email, music, games, e-commerce, and many other suitable applications.

In block 104, a user device may receive at least one non-touch gesture input or command to affect or control an application, for example, via an input component 1516 illustrated in FIG. 7. Non-touch interactive gesture inputs or commands may include poses or motions using an object such as a hand, a finger, a pen, etc. directly over the user device interface (e.g., on-screen), or off the user device interface such as on a side, top, bottom or back of the user device (e.g., off-screen). In various embodiments, a user device may include interactive input capabilities such as gaze or eye tracking, e.g., as part of input component 1516 illustrated in FIG. 7. For example, a user device may detect the user's face gazing or looking at the user device via image or video capturing capabilities such as a camera.

In embodiments herein, user devices may include mobile devices, tablets, laptops, PCs, televisions, speakers, printers, gameboxes, etc. In general, user devices may include or be a part of any device that includes non-touch gesture recognition, that is, non-touch gestures may generally be captured by sensors or technologies other than touch screen gesture interactions. For example, non-touch gesture recognition may be done via ultrasonic gesture detection, image or video capturing components such as a camera (e.g., a visible-light camera, a range imaging camera such as a time-of-flight camera, structured light camera, stereo camera, or the like), depth sensor, IR, ultrasonic pen gesture detection, etc. That is, the devices may have vision-based gesture capabilities that use cameras or other image tracking technologies to capture a user's gestures without touching a device (i.e., non-touch gestures such as a hand pose in front of a camera), or may have capabilities to detect non-touch gestures other than vision-based capabilities.

Also, non-touch gesture capturing sensors or technologies may be a part of a user device or system located on various surfaces of the user device, for example, on a top, a bottom, a left side, a right side and/or a back of the user device such that non-touch gestures may be captured when they are performed directly in front of the user device (on-screen) as well as off a direct line of sight of a screen of a user device (off-screen).

In block 106, the received interactive input may be associated (e.g., by a processing component 1504 illustrated in FIG. 7) with an active application, for example, with an active application that is not displayed on the user device interface, but is instead running in the background (“background application”). In this regard, the background application is different than the displayed foreground application. For example, an email application may be running and being displayed in the foreground of a user device interface while a music application may be running in the background.

In block 108, the input command (e.g., as received via input component 1516 illustrated in FIG. 7) may be applied (e.g., by processing component 1504 illustrated in FIG. 7) to the background application without affecting the foreground application. For example, a user may use gestures to control a music application that is running in the background while the user is working on a displayed email application such that the gestures do not interfere with the email application.

As such, according to one or more embodiments, a user may have the ability to control an active application running in the background from a screen displaying a different foreground application. Also, in various embodiments, the user may have the ability to bring the active application running in the background to the foreground.

Embodiments of the present disclosure may apply to many use cases wherein a user may use interactive inputs (e.g., non-touch gestures) such that a system may apply an associated interactive input to an application other than an application that is displayed on a user device without affecting or interrupting a foreground application. Examples of use cases may include the following:

Use Case: Music Control while an Email Application is Displayed

Referring to FIG. 2, a flow diagram illustrates a music control use case according to an embodiment of the present disclosure. In block 202, a user device or system may have an active music control screen displayed on an interface of the user device, for example, via a display component 1514 illustrated in FIG. 7.

In block 204, the system may provide a gesture mode as requested wherein the user may control the music control screen via non-touch gestures. In block 206, non-touch gesture capturing sensors or technologies such as ultrasonic technology may be turned on, and may be a part of input component 1516 illustrated in FIG. 7).

In block 208, upon receiving an email, and based on a user's request or inputs, the system determines (e.g., by processing component 1504 illustrated in FIG. 7) whether to display an email screen. If the system receives an input indicating that the user does not want to view the email screen, the system goes to block 212 and the music screen continues to be displayed on the user device interface.

But if the system receives an input indicating that the user wants to view the email screen (for example, because the user may want to reply to the email), the system goes to block 210 and an email screen is displayed on the user device interface, for example, via display component 1514 illustrated in FIG. 7. Notably, the music application continues to run in the background.

In block 214, a gesture icon associated with the music application may be displayed on the email screen, e.g., by display component 1514 illustrated in FIG. 7. In an embodiment, a gesture icon such as a gesture icon 216 may float on top of the email screen or otherwise be displayed on the email screen. Gesture icon 216 may indicate that the music application, which continues to run in the background, may be associated and controlled with specific gesture inputs. In general, a gesture icon such as gesture icon 216 may be of any form, size or shape to indicate that a background application may be associated and controlled with gesture inputs. In this example, gesture icon 216 includes an open hand with music notes over a portion of the hand. In other embodiments, the music notes may be replaced by an indication of another running program (e.g., car navigation systems, radio, etc.) when that other running program may be associated and controlled with specific gesture inputs. In various embodiments, the hand portion of gesture icon 216 may be used as an indicator of a gesture, for example, it may indicate a closed first instead of an open hand, or a hand with arrows indicating motion, or any other appropriate indicator of a gesture.

In block 218, the system may determine whether the user wants to input a command for the background application, e.g., the user may want to input a command to skip a song for the music application (e.g., via input component 1516 illustrated in FIG. 7).

In block 222, if the user does not want to input a command for the music application such as to skip a song, there is no action. In block 226, the system may then wait for another non-touch gesture input (e.g., a hand gesture) to control the music application.

In block 220, if the user wants to input a command for the music application such as to skip a song, the user may use a specific non-touch gesture input, for example, a hand gesture associated with skipping a song (e.g., via input component 1516 illustrated in FIG. 7). Upon receiving or detecting the specific non-touch gesture input, in block 224, the music application plays the next song.

As such, while the user is on the email screen, the user may use non-touch gesture inputs (e.g., a hand pose and/or a dynamic gesture) to control the music application and give commands, such as “like”, “dislike”, “skip to the next song”, “yes, I am still listening”, etc. on a music application such as Pandora™. Conveniently, the user may continue interacting with the email application (e.g., typing or reading an email) while listening to music.

Use Case: Phone Call in Background

A user that is on a phone call on a user device may go to a contact list screen displayed on the user device to look for a phone number or to another application for another purpose, for example, to a browser to review Internet content or to a message compose screen. From the contact list screen or other application, the user device may detect user inputs such as a non-touch gesture (e.g., a hand pose) to input commands for controlling the phone call, for example, to mute, change volume, or transition to a speaker phone. As such, the user device may respond to user inputs that control the phone call running in the background while the contact list or other application is displayed on the screen of the user device.

There are many other use cases where background tasks or applications may be controlled while running an active foreground application. Examples of background tasks or applications may include: turning a flashlight on/off; controlling a voice recorder, e.g., record/play; changing input modes, e.g., voice, gestures; controlling turn by turn navigation, e.g., replay direction, next direction, etc.; controlling device status and settings, e.g., control volume, brightness, etc.; and many other use cases. It should be appreciated that embodiments of the present disclosure may apply to many use cases, including use cases which are not described herein.

Referring to FIG. 3, a flow diagram illustrates a method for determining an application to which interactive inputs apply according to an embodiment of the present disclosure. According to one or more embodiments, a system may have the ability to determine to which active application, either a background application or a foreground application, specific interactive inputs such as specific non-touch gesture events may be applied. Several factors may determine to which active application specific interactive inputs such as specific non-touch gesture events may apply. For example, a factor may include whether a foreground application has the ability to support interactive inputs such as non-touch gesture events.

In block 302, as described above according to one or more embodiments, a user device interface may run (e.g., display such as on a display component 1514 illustrated in FIG. 7) an active application (“foreground application”) while another application is running in the background (“background application”). In some embodiments, no elements of the background application are displayed while the foreground application is in focus or being displayed by the user device.

In block 304, the system determines (e.g., using processing component 1504 illustrated in FIG. 7) whether the foreground application has the ability to support interactive inputs such as non-touch gesture events that may be received, e.g., via input component 1516 illustrated in FIG. 7).

In block 306, if the system determines that the foreground application itself does not support interactive inputs such as non-touch gesture events, then another application (e.g., the last application which registered with a gesture interpretation service and has the ability to support non-touch gesture events), or for example the background application, may receive the non-touch gesture events. In one or more embodiments, a service or process (e.g., via processing component 1504 illustrated in FIG. 7) may be running to identify, interpret and/or assign gesture events as will be described in more detail below. In an embodiment, a global gesture look-up table, for example as illustrated by Table 1 and Table 2 below, may include a plurality of gestures and a corresponding application and command for that application, for example to indicate that Gesture X corresponds to an input Command X for a specific application APP1. In some embodiments, certain applications may have pre-assigned gestures to carry out specific commands for the application.

If the system determines that the foreground application is configured to receive interactive inputs such as non-touch gesture events, e.g., via input component 1516 illustrated in FIG. 7, there may be various possibilities including the following two possibilities:

In block 308, Possibility 1 may occur wherein the foreground application is registered for a different set of non-touch gesture events than the background application(s). That is, specific non-touch gestures may be registered and used only in connection with a specific application or task. In this case, in block 312, the gesture system (e.g., by processing component 1504 illustrated in FIG. 7) may route the specific non-touch gesture events to the appropriate application allowing both applications to receive non-touch gesture events concurrently. A method for using gestures registered to control an application is described below with respect to FIG. 4 according to an embodiment of the present disclosure. In an embodiment, a global gesture look-up table, for example as illustrated by Table 1 and Table 2 below, may include a plurality of gestures and a corresponding application and command for that application, for example to indicate that Gesture X corresponds to an input Command X for a specific application APP1. In some embodiments, certain applications may have pre-assigned gestures to carry out specific commands for the application. In one or more embodiments, a service or process (e.g., via processing component 1504 illustrated in FIG. 7) may be running to identify, interpret and/or assign gesture events. Also, gesture events may be unique, or the service or process may ensure that applications do not register for the same gesture events (e.g., either by not allowing overwriting of existing gesture associations, or by warning the user and letting the user choose which application will be controlled by a given gesture, etc.). Of course, two applications in particular may merely accept different gestures. In an embodiment, if the foreground application supports gestures, it may attempt to interpret a detected gesture, and if it does not recognize the detected gesture, it may pass information regarding the gesture to another application or to a service or process that may determine how to handle the gesture (e.g., transmit the information to another application, ignore it, etc.). Or, in another embodiment, the service or process may detect motion first, determine a gesture corresponding to the motion, and then selectively route gesture information to an appropriate application (foreground application, one of a plurality of background applications, etc.).

In block 310, Possibility 2 may occur wherein the foreground application is registered for at least one of the same non-touch gesture events as the background application. In this case, in block 314, an application selection procedure may be performed (e.g., via processing component 1504 illustrated in FIG. 7). That is, conflict resolution may be performed for determining which application should receive a detected gesture event that may be registered for both a foreground application and one or more background applications. Notably, there may be no need for the foreground application to lose focus. FIG. 5 described below is a diagram illustrating a gesture application selection procedure according to an embodiment of the present disclosure.

Referring now to FIG. 4, a flow diagram illustrates a method for using non-touch gestures registered to control an application according to an embodiment of the present disclosure.

In block 402, non-touch gestures may be assigned to corresponding commands or inputs for specific applications in a global gesture look-up table (that may be stored, for example, in a storage component 1508 illustrated in FIG. 7). For example, a global gesture look-up table, for example as illustrated by Table 1 and Table 2 below, may include a plurality of gestures and a corresponding application and command for that application, for example to indicate that Gesture X corresponds to an input Command X for a specific application APP1. In some embodiments, certain applications may have pre-assigned gestures to carry out specific commands for the application. In some embodiments, a service or module (e.g., via processing component 1504 illustrated in FIG. 7) may manage the associations between gestures, commands, and applications, and may function to resolve any conflicts and/or potential conflicts. In some embodiments, an application may register with the function or module upon initialization or at startup of the system 1500, and the application or module may determined whether a particular gesture may be assigned to a particular application and/or command.

Table 1 illustrates example gestures with corresponding example commands and application assignments according to an embodiment of the present disclosure.

TABLE 1
Example gestures with example commands
and application assignments

| Gesture | Command | Application |
|---|---|---|
| Cover sensor (e.g. | Mute/unmute | Phone call |
| with an open palm) | | |
| Swipe Right (e.g., | Skip to next song | MP3 player |
| with an open hand | | |
| motion) | | |
| One finger over | Start/stop | Voice recorder |
| device screen | | |
| Two fingers over | Change input | Settings |
| device screen | mode | |
| Swipe Up | Increase brightness | Settings |

A global gesture look-up table (e.g., Table 1) may indicate that Gesture X is assigned or corresponds to an input Command X for a specific Application APP1. For example, a hand pose such as an open palm gesture in the form of a “Cover” may correspond to a command for “Mute/unmute” and is assigned to a Phone Call application. A “Swipe Right” gesture (e.g., with an open hand motion) may correspond to a command for “Skip to next song” and is assigned to an MP3 player application. A “One finger over” gesture may correspond to a “Start/stop” command and is assigned to a Voice recorder application, and so on.

Alternatively, a global gesture look-up table (e.g., Table 2) may assign commands based on a current output state of a user device, but may not be related to focus of the application being affected.

TABLE 2
Example assignments based on output state

| Gesture | Command | Application |
|---|---|---|
| Cover | Silence/Pause/Mute | If not in call, then apply |
| | | to currently playing audio. e.g. |
| | | ringtone, alarm = silence, |
| | | Pandora, MP3 = Pause . . . |
| | | If in call, then mute |
| | | microphone. |
| Swipe Right | Skip to next song | Currently playing music |
| | | player. |
| | | E.g. Pandora, MP3 |
| | | player . . . |
| Swipe Up | Increase output | If audio is playing from any |
| | | application, increase volume |
| | | (Call, Music, Video, Navigation, |
| | | etc.) |
| | | If no audio is playing, increase |
| | | brightness (Settings) |
| One finger over | Swap focus app | Previously focused application |
| | | (used repeatedly, toggles |
| | | between applications) |

As illustrated in Table 2, a “Cover” gesture may correspond to a “Silence”, “Pause” or “Mute” command depending on the application based on the current output of the user device. For example, if a user device is not running a phone call application, then the “Cover” gesture may be applied to another audio playing application such as a ringtone, an alarm (applying a “silence” command), or Pandora™ or MP3™ (applying a “pause” command) If the user device is running a phone call application, then a “Mute” command may be applied (as illustrated in the example of Table 1).

In some embodiments, one or more applications may access a lookup tables, such as one or both of the lookup tables above, when a gesture has been detected. Such access may be performed, for example, via an application programming interface (API). The application may be informed about which gesture command to apply, for example through the API. In some embodiments, the API may also indicate, e.g., based on the lookup table(s) whether there is a conflict with a gesture and if so, how to mediate or resolve the conflict.

Referring back to FIG. 4, in block 404, the system may receive inputs from a user (e.g., via input component 1516 illustrated in FIG. 7) to initiate a first application (e.g., APP1), which may have associated gestures in a global gesture look-up table. For example, a user may want to start a phone call, which has associated gestures, for example, a “Cover” gesture may correspond to “Mute/unmute” of a phone call as set forth in the example of Table 1. In some embodiments, blocks 402 and 404 may be performed in reverse order. For example, instead of first mapping potential gestures to applications at 402, an application may be initialized at 404 and the application may register with a service, which may add the gestures accepted by the application to a stack, look-up table(s), database, and/or other element that may store associations between gestures, commands, and application. In various embodiments, upon initiating an application, the system may indicate or verify that the application has associated gestures provided in a gesture lookup table such as Table 1 or Table 2 described above, which may be stored for example in storage component 1508 illustrated in FIG. 7. In some embodiments, access to the global gesture lookup table(s) may be provided via display component 1514 illustrated in FIG. 7, for example, in the form of a link, icon, a pop-up window, in a small window, etc. such that the user may determine which gestures are available at any given time, determine which mappings have been created in the look-up table, and/or edit associations in the table. In some embodiments, however, the table(s) are not accessible to the user. In some such embodiments, the table(s) may only be accessed by an application or program configured to accept gestures and/or a service as discussed above that may manage associations between gestures, commands, and applications. In some embodiments, a user interface based on the table(s) may be displayed to a user to allow the user to resolve a conflict or potential conflict between a plurality of gesture command associations.

In block 406, the system may receive inputs from the user (e.g., via input component 1516 illustrated in FIG. 7) to initiate a second application (APP2). The second application (APP2) becomes the focused application and is displayed on the user device interface (e.g., via display component 1514 illustrated in FIG. 7). APP2 may receive inputs from any number of modalities, including touch input and/or non-touch or gestural inputs.

In block 408, optionally, the user interface (e.g., display component 1514 illustrated in FIG. 7) may indicate that gestures are available and that they may affect the first application APP1. For example, an icon in a header may float or be provided or displayed, e.g., an icon such as icon 216 illustrated in the example of FIG. 2.

In block 410, user inputs may be received (e.g., via input component 1516 illustrated in FIG. 7) wherein the user performs a non-touch gesture X (for example, one of the gestures listed above in Table 1 or Table 2 according to an embodiment).

In block 412, an assigned input Command X performed on the first application APP1 may be detected while the second application remains in focus. For example, a “Cover” gesture performed by the user may be detected and a corresponding command to “mute” may be applied (e.g., via processing component 1504 illustrated in FIG. 7) to a phone call (APP1) while the user device is displaying a focused application APP2 (e.g., via display component 1514 illustrated in FIG. 7).

Referring now to FIG. 5, a block diagram illustrates handling active gesture application selection according to an embodiment of the present disclosure. In embodiments where a foreground application and a background application are registered for at least one common interactive input event such as a non-touch gesture event, the user may be enabled to identify which application should receive the interactive input (i.e., non-touch gesture) event.

In block 502, the system may begin handling an active gesture application where the foreground application and the background application are registered for at least one common interactive input (e.g. non-touch gesture).

In block 504, the system determines whether a gesture designating a background application to control has been detected. A user may want to control a background task or application. For example, inputs may be received via a user device interface (e.g., via input component 1516 illustrated in FIG. 7) indicating that the background application is to be affected or controlled as will be described in more detail below in connection with blocks 508-514 according to one or more embodiments. Blocks 508-514 present different embodiments of determining whether a gesture designating a background application to control has been detected, and embodiments for responding thereto. These blocks, however, are not necessarily performed concurrently, nor do they necessarily comprise mutually exclusive embodiments. Further, they are not exhaustive, as other processes may be used to determine whether a gesture designating a background application to control has been detected and/or to control such application.

In block 506, if a gesture designating a background application to control is not detected (e.g., the user does not want to control a background task), a default application selection may occur such that an interactive input connection, e.g., a gesture connection, has priority by default for an application that is in “focus,” for example, the application that is displayed on a user device interface. For instance, if a user uses a non-touch gesture event such as the user raising his or her hand in an engagement pose, then the application in focus receives that engagement pose and responds as it normally would, without consideration to the background task that may be registered for the same gesture. Otherwise, if a user wants to control a background task, then there may be several options, including the following.

In block 508, if it has been detected that a user has maintained an engagement pose for a predetermined period of time, an overlay system may be displayed that allows a user to switch to control a background application. For example, in an embodiment where an interactive input includes an engagement gesture, the system may detect a user's engagement gesture pose maintained for a predetermined period of time, for example, an extended period of time (e.g., an open hand held in front of a user interface for 2-3 seconds) with respect to the time required for engagement of the foreground application. Thus, maintaining an engagement pose for a certain period of time may engage the foreground application, while maintaining the engagement pose for a longer period of time may engage the background application. In various embodiments, feedback may be provided for engaging a foreground application or a background application; for example, there may be one beep when a foreground application is engaged or two beeps when a background application is engaged. In other embodiments, an icon may appear when a foreground application is engaged, and the icon may be augmented, for example, with music notes (or other indication of which application is being controlled) when a background application is engaged. That is, in an embodiment, detection of a user's engagement gesture pose maintained for a predetermined period of time, which may correspond to engagement of a background application, may be followed by a gesture overlay system entering into a “system mode” where it displays gesture selectable application icons allowing the user to switch the gesture system in order to control a background application. For example, a gesture overlay system may comprise, for example, a glowing blue icon superimposed on a screen of a user device. Other examples of an overlay may include a box or an icon such as gesture icon 216 illustrated in the example of FIG. 2, which may appear to float on top of the user device's interface or screen. An icon such as gesture icon 216 may indicate that an application may continue to run in the background and may be associated with specific gesture inputs (e.g., a music application). In general, a gesture overlay system may be of any form, size or shape to indicate that a background application may be associated and controlled with gesture inputs. Notably, voice or other processes or types of inputs may be used to select the active gesture application as well. In some embodiments, instead of showing an overlay that indicates which background application is being controlled, a plurality of selectable icons (each corresponding to a background application) may be displayed in the overlay such that the user may select which background application to control.

In block 510, if it has been detected that a user has maintained an engagement pose for a predetermined period of time, the system 1500 may switch to controlling the gesture control application to the background application without loosing focus on the foreground application. In an embodiment where an interactive input by a user includes an engagement gesture, the system may detect the user's engagement gesture pose maintained for a predetermined or an extended period of time (e.g., an open hand held in front of a user interface for 2-3 seconds) with respect to the time required for engagement of the foreground application. Thus, detecting an engagement pose maintained for a certain period of time may engage the foreground application, while detecting the engagement pose maintained for a longer period of time may engage the background application. In various embodiments, feedback may be provided for engaging a foreground application or a background application, for example, there may be one beep when a foreground application is engaged or two beeps when a background application is engaged. In other embodiments, an icon may appear when a foreground application is engaged, and the icon may be augmented, for example, with music notes (or other indication of which application is being controlled) when a background application is engaged. That is, in an embodiment, detection of a user's engagement gesture pose maintained for an extended period of time, which may correspond to engagement of a background application, may be followed by the system automatically switching to the gesture application in the background task. In this case, a user interface may change to reflect an overlay of the background application without losing focus on the foreground application, or it may reflect that control has changed using another type of visual or auditory processes.

In various embodiments an overlay system may comprise, for example, a glowing icon superimposed on a screen of a user device. Other examples of an overlay may include a box or an icon such as icon 216 illustrated in the example of FIG. 2, which may appear to float on top of the user device's interface or screen.

In embodiments where there may be several background applications registered for gesture events, then these applications may be sequentially stepped through if desired. Alternatively, a “gesture wheel” may appear on the user interface, which may allow a user to select a desired gesture application more quickly. For example, a representation in the form of a wheel or an arc may appear to float on top of a screen and may be divided into sections, each section corresponding to a background application, e.g., a music note in one section may correspond to a music application, a phone icon in another section may correspond to a phone application, and so on. A background application may be selected by selecting the corresponding section, for example, by detecting a swipe and/or position of a hand.

In block 512, if a user pose associated with a background application has been detected, the background application may be engaged. In an embodiment where the system 1500 accepts several engagement gesture poses, for example, a user's specific pose may be detected to signify that the user wishes to engage with a particular background application associated with that specific pose. For instance, an open palm hand pose may always engage a foreground application while a two fingered victory hand pose may directly engage a first background application in some embodiments and a closed first gesture may directly engage a second background application. Thus, specific applications may uniquely be registered to correspond to certain hand poses so that they always respond when a specific hand pose is detected. These background-specific gestures may be determined a prior and/or may be persistent, or may be determined at runtime.

In block 514, if a gesture for selecting between two or more applications has been detected, the system 1500 may switch between applications. For example, in an embodiment where the system 1500 supports a plurality of different gestures, a particular non-touch gesture may be allocated for selecting between two or more gesture applications. For instance, if a “circle” gesture in the clockwise direction is allocated solely to this purpose, then when the “circle” gesture is detected, the system may select another gesture application or the next gesture application in a list of registered gesture applications.

It should be noted that in the different possibilities for handling active gesture application selection where a foreground application and a background application are registered for at least one common gesture event as described above according to one or more embodiments, if there is no background gesture application present, then a generic “system gesture menu” or “gesture wheel” may appear, which may be swiped with one hand, and may be used as an application launcher or other default behavior (e.g., phone dialer, voice recorder, etc.).

In some embodiments, a task referred to herein as a background task comprises a task being run and/or displayed on a secondary device or monitor. Gestures which affect and/or control the secondary device or display may be detected by the system 1500 in some such embodiments without affecting operation of a foreground application being run and/or displayed on the system 1500. For example, a user may have a secondary display device where a secondary task is controlling the data displayed. The secondary display device may be a heads up display integrated into a pair of glasses, or a display integrated into a watch, or a wireless link to a TV or other large display in some embodiments. In this example, the primary display may be used for any primary task that the user selects, yet simultaneously the user would be enabled to control the secondary tasks on the secondary display through gestures. In some such implementations the hardware used for the gesture detection could either be associated with the secondary display or integrated into the primary device. The system may be able to control the secondary task based on user gestures without interfering with the operation of the primary task on the primary device display. In some embodiments, any icons or user interface components associated with the gestures may be displayed as part of the secondary display, rather than on the primary display, to further guide the user with respect to gesture control options.

According to one or more embodiments, for any of the possibilities described above for handling active gesture application selection where a foreground application and a background application are registered for at least one common gesture event, it may be possible to use a function that may be referred to as “sticky gestures”. In this regard, “sticky gestures” may refer to instances where an application that receives a notification of engagement may receive other gestures that may be selected by the user in different ways, including for example:

A. In an embodiment, one method for the user to identify which application receives gestures may include having the application be explicitly configured as a system setting. As an example, a user may configure the gesture system so that “if my music application is running in the background, then all gestures are routed to it”. This may prevent a foreground application from receiving any gestures unless the user explicitly changed modes.

B. In another embodiment, a method for the user to identify which application receives non-touch gestures may include having a prompt occur whenever a gesture engagement occurs and there are more than one application registered for receiving events from the gesture system. At this point, the user may select either one of the background applications or the foreground application by using interactive inputs such as non-touch gestures or through any provided selection process. Once the user finishes the gesture interaction with the selected application, the system may either: i) enable “sticky gestures” so that the next time that gesture engagement occurs, the system may automatically connect to the last selected application, or ii) it may be configured to prompt every time, or iii) it may be configured to prompt if there is a change in the list of applications registered for the gesture system.

C. In yet another embodiment, another way for the user to identify which application receives non-touch gestures may include combining an “extended engagement” technique with “sticky gestures”. In this embodiment, a first engagement with a newly running application may bring up its own gesture interface. If the user extended the engagement (for example, by holding a hand still) or otherwise signaled a desire to switch modes, then the user may get access to one of the background applications. On the next engagement, the “sticky gestures” may be in operation and the gesture system may connect directly to the application selected the previous time. The user may choose to repeat the extended engagement at this point and revert to the foreground application if desired.

Referring now to FIG. 6, a diagram illustrates an example of handling a background task gesture according to an embodiment of the present disclosure. This embodiment may be implemented similarly to the method illustrated in the embodiment of FIG. 2. For example, at 602, in an initial State A, a music application may be playing and may be registered for 3 gestures: Left, Right and Up. In this embodiment, Left may cause the music application to go back one track, Right may cause the music application to go forward one track, and Up may cause the music application to pause the playback of music.

At 604, in a State B, a phone call may be received. The phone call application may take priority and register for the Left and Right gestures. In this State B, the Left and Right gestures may no longer be forwarded and applied to the music application, but may instead be used to either answer the phone call (Right gesture), or send the phone call to voice mail (Left gesture). If the user does an Up gesture while the phone is ringing, then the music will pause because the Up gesture is still being forwarded and applied to the background application. Once the phone call is completed, the system returns to a State C 606 where only the music application is registered for gesture events, and hence Right, Left and Up gestures may all be forwarded and applied to the music application.

According to one or more embodiments of the present disclosure, a gesture service may be implemented that may manage gesture data in a system. The gesture service may keep track of which applications utilize which gestures and/or resolve potential conflicts between applications which use similar gestures. The gesture service may be configured to associate specific non-touch gestures with specific applications, or register each application for specific non-touch gestures when that application launches, and unregister for the specific non-touch gestures when the application exits.

In an embodiment where only one gesture application is running, the service may simply send to that application all messages that it had registered for. In another embodiment where a new application launches and becomes the foreground application, and the previously registered gesture application continued to run but was now in the background (e.g., a music player application), then the foreground application may get precedence for all gesture events that are associated with it. As such, if the background application had registered for the same non-touch gesture events that the foreground application registered for, then the foreground application may receive those non-touch gesture events instead of the background application. If there were any non-touch gesture events for which the background application was registered, but for which the foreground application was not registered, then the background application may continue to receive such non-touch gesture events. If the foreground application were to quit or exit, then the background application may be restored as the primary receiver of any of those gestures that had been usurped by the foreground application. In another embodiment, the first application to register a gesture may maintain control of the gestures. In yet another embodiment, a user may be prompted to select which application is controlled by a certain gesture when there is a conflict. In another embodiment, the application which “owns” a gesture may be assigned based on frequency of use of the application, importance (e.g., emergency response functions are more important than music), or some sort of hierarchy or priority.

In an embodiment where a user may want to input non-touch gesture events to the background application, and where the non-touch gesture events were also registered to the foreground application, then the service may provide a mechanism to implement gesture message switching, for example, as described above with respect to the embodiment of FIG. 5. One example for implementing this may be to use an extended non-touch gesture, for instance a static hand pose that is held for an extended period of time or a custom gesture such as a unique hand pose, or any other mechanism to invoke a special “gesture mode overlay”. The overlay may be drawn or floated by the service on top of everything currently on the display without affecting the currently foreground application. The overlay may indicate which application will currently receive or be affected by gesture inputs, or may indicate a plurality of applications (background and/or foreground) which may be selected to receive gesture inputs. Once the system is in the special gesture mode overlay state, the user may be prompted to select which application should receive gestures. As an example, the icons for the two applications (foreground and background) may be shown and the user may select them with a simple gesture to one side or the other. Alternatively, a larger number of options may be shown and the user may move his or her hand without touching the screen and control a cursor to choose the desired option. Once the user has selected the desired option (for instance the background application) then the service may change the priority of registered gestures to make the background application the higher priority service and it may begin receiving gesture messages that were previously usurped by the foreground application. This “sticky” gesture mode may remain in effect until the user explicitly changed it using the gesture mode overlay or if one of the applications exited.

In one or more embodiments, a list, library or vocabulary of gestures associated with an application may change based on the applications that register. For example, a music application may be registered for gestures including Left, Right motions, where Left may cause the music application to go back one track, and Right may cause the music application to go forward one track. Subsequently, a phone application may also register for gestures including Left, Right motions, where Left may cause the phone application to send a call to voicemail, and Right may cause the phone application to answer a phone call. In some embodiments, the commands associated with Left and Right will change when the phone application registers. Further, if a browser application subsequently registered for gestures including a Circle gesture to refresh a webpage and an Up motion to bookmark the webpage, additional gestures may be available for use by the user in comparison to when just the music application and phone application were registered. As such, the list, library or vocabulary of gestures may change based on the registered applications (or their priority).

According to one or more embodiments of the present disclosure, the system may provide notifications of actions associated with an application, for example, pop-up notifications may be displayed on a screen of a user device, e.g., near an edge of corner of a display when new email is received or when a new song is starting to play. An application which is associated with a pop-up notification may have priority for gestures for a certain amount of time (e.g., 3-5 seconds) after the pop-up notification appears on the screen, or while the pop-up notification is being displayed. A user may have the option to dismiss the pop-up notification with a certain gesture, or otherwise indicate that he or she does not want to control the application associated with the pop-up notification.

Advantageously, according to one or more embodiments of the present disclosure, background applications may be controlled by associated commands even if the application is not in focus. Furthermore, unlike typical systems that use dedicated interfaces such as buttons or voice commands where a user may have to remember and say a verbal command, in embodiments herein, a limited number of gestures may simultaneously be assigned to different applications, which may make them easier for the user to remember. Thus, even where an available vocabulary of gestures is small, a user may effectively interact with a number of applications.

Referring now to FIG. 7, a block diagram of a system for implementing a device is illustrated according to an embodiment of the present disclosure.

It will be appreciated that the methods and systems disclosed herein may be implemented by or incorporated into a wide variety of electronic systems or devices. For example, a system 1500 may be used to implement any type of device including wired or wireless devices such as a mobile device, a smart phone, a Personal Digital Assistant (PDA), a tablet, a laptop, a personal computer, a TV, or the like. Other exemplary electronic systems such as a music player, a video player, a communication device, a network server, etc. may also be configured in accordance with the disclosure.

System 1500 may be suitable for implementing embodiments of the present disclosure including various user devices. System 1500, such as part of a device, e.g., smart phone, tablet, personal computer and/or a network server, includes a bus 1502 or other communication mechanism for communicating information, which interconnects subsystems and components, including one or more of a processing component 1504 (e.g., processor, micro-controller, digital signal processor (DSP), etc.), a system memory component 1506 (e.g., RAM), a static storage component 1508 (e.g., ROM), a network interface component 1512, a display component 1514 (or alternatively, an interface to an external display), an input component 1516 (e.g., keypad or keyboard, interactive input component such as a touch screen, gesture recognition, etc.), and a cursor control component 1518 (e.g., a mouse pad). As described above according to one or more embodiments, an application may be displayed via display component 1514, while another application may run in the background, for example, by processing component 1504. A gesture service, which may be implemented in processing component 1504 may manage gestures associated with each application, wherein the gestures may be detected via input component 1516. In various embodiments, gesture look up tables such as Table 1 and Table 2 described above may be stored in storage component 1508.

In accordance with embodiments of the present disclosure, system 1500 performs specific operations by processing component 1504 executing one or more sequences of one or more instructions contained in system memory component 1506. Such instructions may be read into system memory component 1506 from another computer readable medium, such as static storage component 1508. These may include instructions to control applications or tasks via interactive inputs, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processing component 1504 for execution. Such a medium may take many forms, including but not limited to, non-volatile media, volatile media, and transmission media. In various implementations, volatile media includes dynamic memory, such as system memory component 1506, and transmission media includes coaxial cables, copper wire, and fiber optics, including wires that comprise bus 1502. In an embodiment, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read. The computer readable medium may be non-transitory.

In various embodiments of the disclosure, execution of instruction sequences to practice the disclosure may be performed by system 1500. In various other embodiments, a plurality of systems 1500 coupled by communication link 1520 (e.g., WiFi, or various other wired or wireless networks) may perform instruction sequences to practice the disclosure in coordination with one another. System 1500 may receive and extend inputs, messages, data, information and instructions, including one or more programs (i.e., application code) through communication link 1520 and network interface component 1512. Received program code may be executed by processing component 1504 as received and/or stored in disk drive component 1510 or some other non-volatile storage component for execution.

Referring to FIG. 8, a flow diagram illustrates a method for controlling an application according to an embodiment of the present disclosure. It should be noted that the method illustrated in FIG. 8 may be implemented by system 1500 illustrated in FIG. 7 according to an embodiment.

In block 802, system 1500, which may be part of a user device, may run a foreground application displayed on an interface of the user device, for example, on display component 1514.

In block 804, the system may run at least one application in a background on the user device. An application may run in the background while a foreground application is in focus, e.g., displayed via display component 1514.

In block 806, the system may detect a non-touch gesture input from a user of the user device, for example, via input component 1516. In various embodiments, non-touch gesture inputs may include poses or motions using an object such as a hand, a finger, a pen, etc. directly over a user device interface (e.g., on-screen), or off the user device interface such as on a side, top, bottom or back of the user device (e.g., off-screen). In various embodiments, a user device may include interactive input capabilities such as gaze or eye tracking.

In block 808, the system may determine (e.g., by processing component 1504) to which of the foreground application and the at least one application in the background the detected non-touch gesture input applies.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for controlling a background application, the method comprising:
detecting a non-touch gesture input received by a user device;
associating the non-touch gesture input with an application running in a background, wherein a different focused application is running in a foreground;
controlling the background application with the associated non-touch gesture input without affecting the foreground application.

2. The method of claim 1, wherein the focused application is displayed on an interface of the user device.

3. The method of claim 2, further comprising displaying an overlay over the focused application on the interface of the user device, wherein the overlay indicates that non-touch gesture inputs are available to affect the background application.

4. The method of claim 1, wherein the non-touch gesture input comprises a pose or a motion by an object, gaze or eye tracking.

5. The method of claim 1, wherein the associating comprises using a global look-up table indicating specific non-touch gesture inputs assigned to corresponding commands for corresponding specific applications.

6. The method of claim 1, further comprising assigning non-touch gesture inputs to corresponding commands for applications based on a current output state of the user device.

7. The method of claim 1, further comprising:
detecting a non-touch gesture input that is registered for the foreground application and the background application; and
selecting an active non-touch gesture input application for applying the detected non-touch gesture input.

8. The method of claim 7, wherein the detecting further comprises detecting an engagement pose designating a background application to control and that is maintained for a predetermined period of time, and providing an overlay that allows a user to switch control to the background application.

9. The method of claim 7, wherein the detecting further comprises detecting an engagement pose designating a background application to control and that is maintained for a predetermined period of time, and automatically switching to control the background application without losing focus on the foreground application.

10. The method of claim 7, wherein the detecting further comprises detecting a specific non-touch gesture input that signifies that a user wants to engage with the background application, the background application being one of a plurality of background applications.

11. The method of claim 7, wherein the detecting further comprises detecting a single non-touch gesture input that is allocated for selecting between two or more applications.

12. The method of claim 7, further comprising enabling a mode in which non-touch gesture input engagement is automatically connected to a last selected application.

13. The method of claim 1, further comprising registering the background application for specific non-touch gesture inputs when the background application launches, and unregistering the background application for the specific non-touch gesture inputs when it exits.

14. The method of claim 1, wherein elements of the background application are not displayed while the focused application is running in a foreground.

15. A method for controlling an application comprising:
running a foreground application displayed on an interface of a user device;
running at least one application in a background on the user device;
detecting a non-touch gesture input from a user of the user device; and
determining to which of the foreground application and the at least one application in the background the detected non-touch gesture input applies.

16. The method of claim 15, further comprising:
determining whether the foreground application and application the background application are registered for a different set of non-touch gesture input events;
if the foreground application is registered for a different set of non-touch gesture input events than the background application, routing the detected non-touch gesture input to an application for which the non-touch gesture input is registered; and
if the foreground application is registered for at least one non-touch gesture input event that is the same as a registered input event for the background application, selecting between the foreground application and the background application.

17. The method of claim 16, wherein the selecting between the foreground application and the background application further comprises: detecting an engagement pose that is maintained for a predetermined period of time and providing an overlay that allows a user to switch control to the background application.

18. The method of claim 16, wherein the selecting between the foreground application and the background application further comprises: detecting an engagement pose that is maintained for a predetermined period of time and automatically switching to control the background application without losing focus on the foreground application.

19. The method of claim 16, wherein the selecting between the foreground application and the background application further comprises: detecting a specific non-touch gesture input that signifies that a user wants to engage with the background application, the background application being one of a plurality of background applications.

20. The method of claim 16, wherein the selecting between the foreground application and the background application further comprises: detecting a single non-touch gesture input that is allocated for selecting between two or more applications.

21. The method of claim 15, further comprising registering the background application for specific non-touch gesture inputs when the background application launches and unregistering the background application when it exits.

22. A device comprising:
an input configured to detect non-touch gesture inputs; and
one or more processors configured to:
run a foreground application displayed on an interface of the device;
run at least one application in a background on the device;
detect a non-touch gesture input; and
determine to which application of the foreground application and the at least one application in the background the detected non-touch gesture input applies.

23. The device of claim 22, wherein the one or more processors are further configured to:
determine whether the foreground application and the background application are registered for a different set of non-touch gesture input events; and
if the foreground application is registered for a different set of non-touch gesture input events than the background application, route the detected non-touch gesture input to an application for which the non-touch gesture input is registered; and
if the foreground application is registered for at least one non-touch gesture input event that is the same as a registered input event for the background application, select between the foreground application and the background application.

24. The device of claim 23, wherein the one or more processors are further configured to: if the foreground application is registered for at least one non-touch gesture input event that is the same as a registered input event for the background application, detect an engagement pose that is maintained for a predetermined period of time and provide an overlay that allows a user to switch control to the background application.

25. The device of claim 23, wherein the one or more processors are further configured to: if the foreground application is registered for at least one non-touch gesture input event that is the same as a registered input event for the background application, detect an engagement pose that is maintained for a predetermined period of time and automatically switch to control the background application without losing focus on the foreground application.

26. The device of claim 23, wherein the one or more processors are further configured to: if the foreground application is registered for at least one non-touch gesture input event that is the same as a registered input event for the background application, detect a specific non-touch gesture input that signifies that a user wants to engage with the background application, the background application being one of a plurality of background applications.

27. The device of claim 23, wherein the one or more processors are further configured to: if the foreground application is registered for at least one non-touch gesture input event that is the same as a registered input event for the background application, detect a single non-touch gesture input that is allocated for switching between two or more applications.

28. The device of claim 22, wherein the one or more processors are further configured to: register the background application for specific non-touch gesture inputs when the background application launches and unregister the background application when it exits.

29. The device of claim 22, wherein the input further comprises at least one of a microphone sensitive to ultrasonic frequencies, an image or video capturing component, a gaze or eye tracking sensor, an infrared detector, a depth sensor, a microelectromechanical system device sensor, and an electromagnetic radiation detector, or a combination thereof.

30. The device of claim 29, wherein the input is located on at least one surface of the device and configured to detect non-touch gesture inputs performed directly in front of the device, or configured to detect non-touch gesture inputs off a direct line of sight of the device.

31. An apparatus for controlling an application comprising:
means for running a foreground application displayed on means for displaying;
means for running at least one application in a background;
means for detecting a non-touch gesture input from a user of the apparatus; and
means for determining to which of the foreground application and the at least one application in the background the detected non-touch gesture input applies.

32. The apparatus of claim 31, further comprising:
means for determining whether the foreground application and the background application are registered for a different set of non-touch gesture input events;
means for routing the detected non-touch gesture input event to an application for which the non-touch gesture input is registered if the foreground application is registered for a different set of non-touch gesture input events than the background application; and
means for selecting between the foreground application and the background application if the foreground application is registered for at least one non-touch gesture input event that is the same as a registered input event for the background application.

33. The apparatus of claim 32, wherein the means for selecting between the foreground application and the background application further comprises: means for detecting an engagement pose that is maintained for a predetermined period of time and means for providing an overlay that allows a user to switch control to the background application.

34. The apparatus of claim 32, wherein the means for selecting between the foreground application and the background application further comprises: means for detecting an engagement pose that is maintained for a predetermined period of time and means for automatically switching to control the background application without losing focus on the foreground application.

35. The apparatus of claim 32, wherein the means for selecting between the foreground application and the background application further comprises: means for detecting a specific non-touch gesture input that signifies that a user wants to engage with the background application, the background application comprising one of a plurality of background applications.

36. The apparatus of claim 32, wherein the means for selecting between the foreground application and the background application further comprises: means for detecting a single non-touch gesture input that is allocated for selecting between two or more applications.

37. The apparatus of claim 32, further comprising means for registering one or more of the at least one application in the background for specific non-touch gesture inputs when the one or more of the at least one application in the background launches, and means for unregistering when the one or more of the at least one application in the background exits.

38. A non-transitory computer readable medium on which are stored computer readable instructions which, when executed by a processor, cause the processor to:
run a foreground application displayed on an interface of a user device;
run at least one application in a background on the user device;
detect a non-touch gesture input; and
determine to which of the foreground application and the at least one application in the background the detected non-touch gesture input applies.
